(19) United States
(12) Patent Application Publication
(10) Pub. No.: US 2009/0099969 A1
(43) Pub. Date: Apr. 16, 2009

(54) Cashless Online Marketplace For Groups And Charities

(76) Inventors: Adam J. Hoeg, Denver, CO (US); Andrew J. Levy, San Francisco, CA (US)

Correspondence Address: K&L Gates LLP, 618 W. Riverside, Suite 300, SPOKANE, WA, 99201-0628, US

(21) Appl. No.: 12/238,419

(22) Filed: Sep. 25, 2008

Related U.S. Application Data
(63) Continuation-in-part of application No. 11/872,708, filed on Oct. 15, 2007.
(60) Provisional application No. 60/975,134, filed on Sep. 25, 2007.

(51) Int. Cl. G06Q 30/00; G06Q 40/00; H04L 9/00; G06Q 90/00

(52) U.S. Cl. 705/80; 705/26; 705/35

(57) ABSTRACT

A cashless online marketplace for the transaction of goods and services. A computer implemented method of acquiring membership, donating and acquiring goods/services via the Internet are described. A computer-implemented method for conducting a cashless online transaction is described, generally comprising the steps of a donor posting an item for donation at a sum of points, an acquirer offering to acquire the item, the donor accepting the acquirer's offer to acquire the item, deducting the sum of points from an account of the acquirer, transferring the item from the donor to the acquirer, notifying the acquirer that the item has been transferred, the acquirer responding to the notification that the item has been transferred by either accepting or disputing the cashless online transaction, and closing the cashless online transaction. Steps wherein the acquirer identifies the item to acquire, the acquirer specifying a transfer option for transfer of the item from the donor to the acquirer from one or more transfer options provided by the donor. An acquirer can respond within a specified period and dispute the transaction. A dispute may result in loss of points in the acquirer's account or the donor's account, or a demerit accruing in the donor's membership record. Upon a specified number of demerits a donor can be prevented from further donating items at the cashless online marketplace. Embodiments addressing the needs and benefits for groups and charitable organizations are disclosed. Apparatus, system and medium embodiments are also disclosed.

### CROSS REFERENCE TO RELATED APPLICATIONS

This application is a continuation in part and claims the benefit of U.S. patent application Ser. No. 11/872,708 filed Oct. 15, 2007, and whose entire contents are hereby incorporated by reference. This application further claims the benefit of U.S. Provisional Application No. 60/975,134 filed Sep. 25, 2007, and whose entire contents are hereby incorporated by reference.

### TECHNICAL FIELD

The present invention pertains to a method and apparatus for a cashless online marketplace on a world wide network such as the Internet, and more particularly to transactions involving groups or charities.

### BACKGROUND

An important use of computers in modern times is the dissemination of information and transacting of business across a wide area network. Currently, the largest wide area computer network in existence is the Internet, although additional world-wide networks similar to the Internet are presently under development and deployment. The Internet originated in the 1960s by the U.S. Defense Department. For a long time, the Internet was used by researchers in universities and national laboratories to share data and information. It is estimated that by 2008 over 700 million of the 1 billion computers worldwide will be connected to the Internet, ranging from basic personal computers to high performance super computers.

In 1989, a new type of information system known as the World Wide Web (the “web”) was introduced to the Internet. The web is a wide area information retrieval system giving users wide access to a universe of documents through a standard format of electronic file, known as the hyper text markup language (HTML). In 1993, researchers at the National Center for Supercomputing Applications (NCSA) released a web browser named “Mosaic” that implemented a graphical user interface (GUI) capable of viewing HTML files. Mosaic was a simple web browser to learn, yet afforded powerful capabilities. Since then, web browsers (i.e. Internet Explorer, Netscape, Firefox, etc.) have evolved into more sophisticated computer applications supporting additional enhanced standards of presenting information, such as Cascading Style Sheets (CSS), Extensible Markup Language (XML), Real Simple Syndication (RSS) and Adobe Flash, among others.

In modern times the web browser, in conjunction with an Internet connection and other computers on a wide area network such as the Internet, provides a platform for offering “web services.” Web services encompass a broad spectrum of information dissemination or transactions that may have been traditionally effected by conventional correspondence means such as typewritten/handwritten paper, telephone or facsimile machines. For example, traditionally a person would go to the bank, or write a letter, to inquire as to one's account balance. In modern times, one can perform the same inquiries, receive the same information and even effect banking transactions (e.g. a transfer from one account to another) via a world wide network such as the Internet.

Paralleling the evolution of the Internet, various marketplaces such as eBay, uBid and other auction websites, or trading websites that trade goods/services such as coins, stamps or other specific items/services, have emerged and evolved into sophisticated websites that are accessible from the typical household that has a web browser and Internet connection.

An example of a specific niche marketplace is BabyLoot, found at the website <www.babyloot.com>. However, with all of the technical sophistication invested into such websites, most websites are primitive in nature (e.g. a bulletin board for posting items) and still struggle or wholly fail to address a way to ensure a fair transaction between the parties. Moreover, there is an absence of incentives for each party to follow through with a transaction promptly.

Further, most websites conduct their marketplace using cash, which inherently breeds distrust among consumers who are paying for goods/services sight unseen. In this regard, a cashless marketplace has several advantages and generally minimizes the perceived risk in the eyes of a prospective acquirer or donor. Similarly, certain groups and charitable organizations could have substantially more efficient communications and activities through such an improved infrastructure.

Given the above problems experienced in prior art online marketplaces, a new approach for the transaction of goods/services through a cashless online marketplace is badly needed. Preferably, such an approach would be one that fits within a typical consumer's Internet experience, thus not requiring that a consumer change their Internet habits.

### SUMMARY

Embodiments of the present invention are directed toward a cashless online marketplace for the fair, intuitive and efficient coordination of the transaction of goods and services. In a best mode contemplated in an embodiment of the invention, a computer implemented method of acquiring membership, donating and acquiring goods/services via the Internet are described. Various approaches regarding activities of membership, donation, acquisition, dispute resolution and administrative functions are disclosed herein.

According to one aspect, a computer-implemented method for conducting a cashless online transaction is described, generally comprising the steps of: a donor posting an item for donation at a sum of points, an acquirer offering to acquire the item, the donor accepting the acquirer's offer to acquire the item, deducting the sum of points from an account of the acquirer, transferring the item from the donor to the acquirer, notifying the acquirer that the item has been transferred, the acquirer responding to the notification that the item has been transferred by either accepting or disputing the cashless online transaction, and closing the cashless online transaction.

Further aspects of the above method are also contemplated, including the steps wherein the acquirer identifies the item to acquire, the acquirer specifies a transfer option for transfer of the item from the donor to the acquirer from one or more transfer options provided by the donor. Such transfer options comprise conventional means for transfer of possession of an item from one to another, including but not limited to: conventional shipping carrier, delivery by the donor, pickup by the acquirer.

In another aspect of the above method, an acquirer can respond to the notification that the item has been transferred with one of the following responses: the acquirer fails to respond to the notification within a specified period, the acquirer accepts receipt and condition of the item, the acquirer disputes receipt of the item, or the acquirer disputes the condition of the item. Such notifications comprise contemporary conventional means of communications, including but not limited to: electronic mail, instant message, facsimile, telephone and postal mail. If a dispute is initiated by an acquirer by its response to such a notification of receipt of the item, typically such a dispute is resolved by a representative of the cashless online marketplace, and may result in loss of points in the acquirer's account or the donor's account, or a demerit accruing in the donor's membership record. If the donor accrues a specified number of demerits, membership can be terminated or the donor can be prevented from further donating items at the cashless online marketplace.

In yet another aspect, a computer-implemented method for an acquirer to acquire goods and services at a cashless online marketplace is described, further detailing the experience of joining and acquiring an item on a cashless online marketplace from the perspective of the acquirer.

Still more aspects of the above method are also directed toward special advertising, privileges, transactions and communications for transactions involving groups and charitable organizations.

Further apparatus, system and medium embodiments of the above disclosed methods are also disclosed.

### BRIEF DESCRIPTION OF THE DRAWINGS

Embodiments of the invention are illustrated by way of example, and not by way of limitation, in the figures of the accompanying drawings and in which like reference numerals refer to similar elements, wherein:

FIG. 1 is a flow diagram depicting a top-level approach for a transaction of an item occurring in a cashless online marketplace according to one embodiment of the invention;

FIG. 2 is a flow diagram depicting an approach for a donor to post an item for donation in a cashless online marketplace according to one embodiment of the invention;

FIG. 3 is a flow diagram depicting an approach for an acquirer to acquire an item for donation in a cashless online marketplace according to one embodiment of the invention;

FIG. 4 is a flow diagram depicting an approach for transferring an item and closing a transaction in a cashless online marketplace according to one embodiment of the invention;

FIG. 5 is a block diagram depicting various modules of computer software upon which embodiments of the invention may be implemented;

FIG. 6 is a block diagram depicting an approach for a cashless online marketplace utilizing a world wide network according to an embodiment of the invention;

FIG. 7 is a block diagram of a computer system architecture upon which embodiments of the invention may be implemented; and

FIG. 8 is a block diagram of a website architecture upon which embodiments of the invention may be implemented.

FIG. 9A is a block diagram depicting a transaction between a donor, an acquirer and a charity according to an embodiment of the invention.

FIG. 9B is a block diagram depicting an alternate transaction between a donor, an acquirer and a charity according to an embodiment of the invention.

FIG. 10 is a flow diagram depicting an approach for a donor to make a charitable contribution through an embodiment of the invention.

### DETAILED DESCRIPTION OF PREFERRED EMBODIMENTS

In the following description, for the purposes of explanation, specific details are set forth in order to provide a thorough understanding of the invention. However, it will be apparent that the invention may be practiced without these specific details. In other instances, well-known structures and devices are depicted in block diagram form in order to avoid unnecessary obscuring of the invention; similarly, steps in the disclosed method are depicted in flow diagram form. Section titles and references appearing within the following paragraphs are intended for the convenience of the reader and should not be interpreted to restrict the scope of the information presented at any given location.

Various aspects and features of example embodiments of the invention are described in more detail hereinafter in the following sections: (i) Functional Overview, (ii) Donor Posting An Item, (iii) Acquirer Acquiring An Item, (iv) Closing Of A Transaction, (v) Examples, (vi) Group Features, (vii) Charity Features, (viii) Implementation Mechanisms and (ix) Conclusion.

### Functional Overview

Embodiments of the present invention are directed toward a cashless online marketplace, preferably embodied as a website on a world wide network such as the Internet, providing a new way to donate or acquire goods or services in an online community.

For purposes of illustration of the present invention, a preferred embodiment of the present invention of a cashless online marketplace is embodied as a website, its method of transacting goods or services, its infrastructure and other aspects of such an embodiment. More particularly, in a best mode, the cashless online marketplace is directed toward the donation, acquisition or re-use of used children's clothing and goods through a website on the Internet. Such a website readily available to those having an Internet connection and web browser thereby helps parents cope with the ever increasing costs of raising and providing for a family in the form of a marketplace designed for cashless transactions. Thus, such embodiments provide members with a way to donate, acquire or re-use goods that are in a high-quality and useable condition, yet are no longer needed. On a macro level, embodiments of the present invention provide individuals with an effective way to re-use goods, emphasizing the tenets of economy, conservation and sharing.

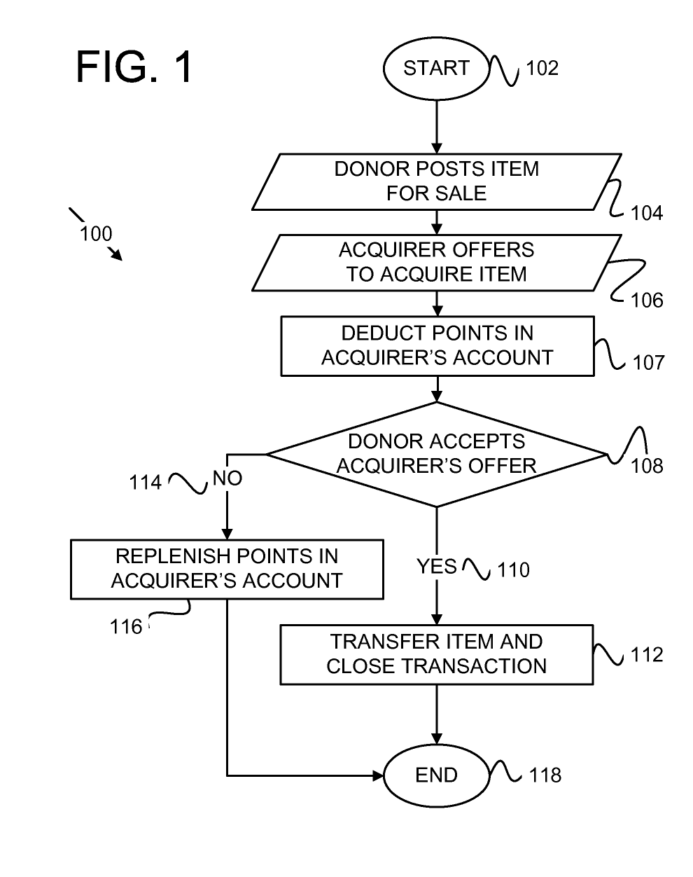

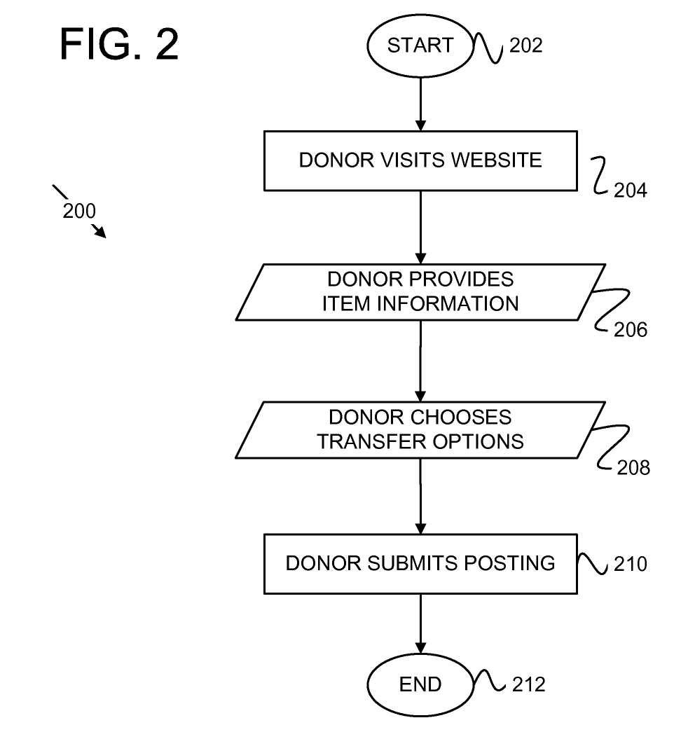

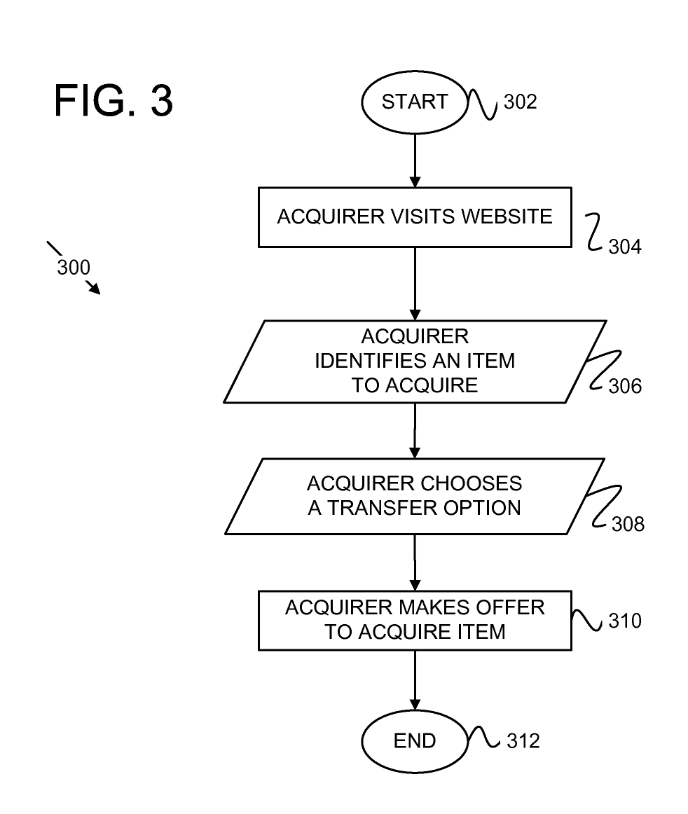

FIG. 1 is a flow diagram 100 depicting a top-level approach for a transaction of an item occurring in a cashless online marketplace according to one embodiment of the invention. After starting the process in step 102, a donor posts an item for donation on the online marketplace in step 104. Step 104 is further detailed in FIG. 2, discussed later in the disclosure. In step 106, an acquirer identifies the item for acquisition and offers to acquire the item through the online marketplace. Step 106 is further detailed in FIG. 3, discussed later in the disclosure. Subsequent to acquirer's offer, a sum of points representing the transaction are deducted from the acquirer's account, as depicted by step 107.

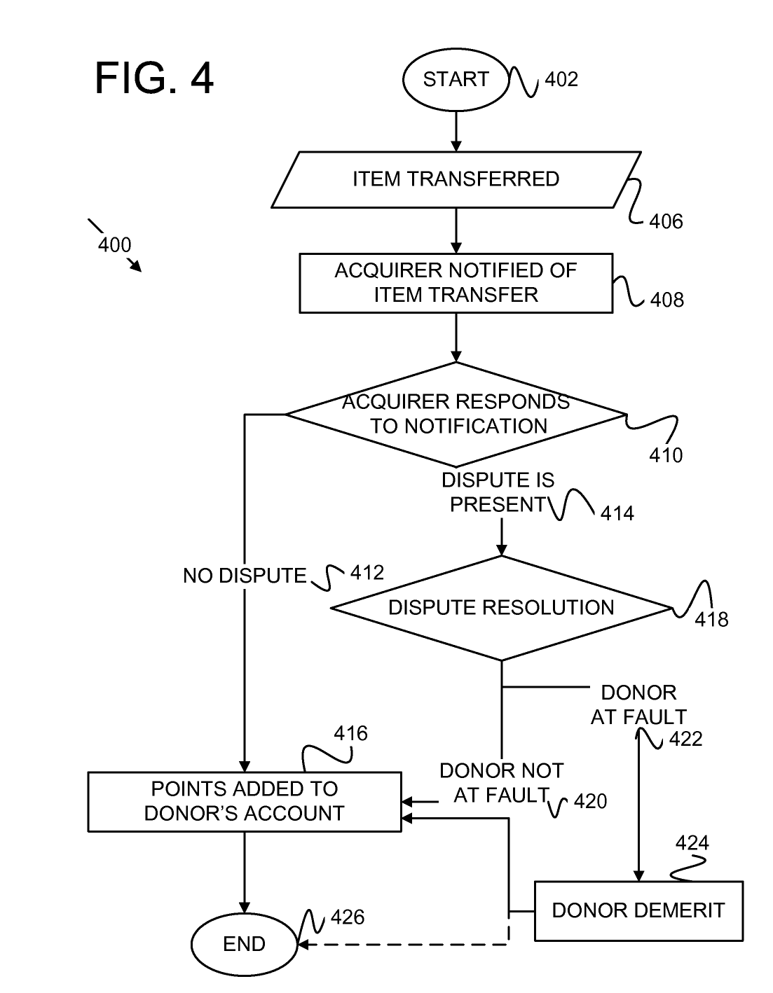

Subsequent to step 107, the donor is provided a notification of the offer to acquire, thereby presented with a choice of accepting (or finalizing) the offer, or alternatively refusing the offer; in step 108, donor responds to the notification. If the offer is affirmatively accepted as depicted in choice 110, then several further steps are conducted to transfer the item to the acquirer, close the transaction and end the process as depicted in steps 112 and 118, respectively. Step 112 is further detailed in FIG. 4, discussed later in the disclosure. If donor does not accept acquirer's offer in step 108, then the prospective transaction between donor and acquirer is cancelled as depicted by the choice 114. Cancellation of the transaction necessarily requires that the sum of points earlier withdrawn or deducted form the acquirer's account be replenished in the acquirer's account, as depicted by step 116. In certain applications where deducting and replenishing a sum of points is not advantageous to occur under the possibility of a cancelled transaction by the donor, an online marketplace can be configured such that step 107 does not occur until after the donor accepts the acquirer's offer in step 108, (thereby eliminating the need for step 116 entirely). Following step 116, it follows that after cancellation of the transaction the end of the process is imminently concluded at step 118.

Therefore, in preferred embodiments, access to steps 104 through 116 of the website are limited to registered members of the website. Typically, such limited membership facilitates an environment of exclusivity, community and trust as evidenced throughout all interactions between the members and the website. Further, it is typically preferable that in order to better facilitate a trusted community, the website is a members-only website and only current members are allowed to refer new members. However, in certain applications it can also be advantageous to have other methods to effect new membership, such as allowing interested users of the website to request more information via an email feedback form.

Different levels of membership can also be preferable in various embodiments of the present invention, which typically render additional features that can be advantageous to certain members. For example, such additional membership features may include, but are not limited to, member forums, online Q&A with experts in the field of goods/services offered, and other community happenings. Multiple levels of memberships can therefore have varying periodic membership fees and terms, which render a recurring revenue stream from the website's existence—without regard to transactional revenue streams.

As noted above, in preferred embodiments new members will be invited to start a membership via an invitation from other members of the website. An existing member will click on the “Refer a friend” hyperlink (or the like) which directs the user to a page requesting basic information about the invitee, (e.g. first and last name, email address, relationship to member, a short message from the member to the invitee, etc.). Upon submitting such information, the website administrator, (preferably as an automated process), forwards an email message to the invitee with the short message and other default information, such as a description of the website, the invitation to join and a hyperlink to the website. The message, hyperlink and information can be edited from time to time by website administrators.

Preferably, when an invitee subsequently clicks on the hyperlink contained in the invitation email, the invitee is validated or verified in some fashion to ensure that the link has been utilized by the proper invitee. One such method that can be utilized is a customized link with a GET URL containing a secure token that verifies it as a valid sign-up request, connecting the request with the originating user.

When a user is brought to the sign up page, the user should be greeted by their first name as provided in the invitation email, and further presented with a Terms & Conditions Agreement and Privacy Policy for acceptance. Preferably, a checkbox that is unchecked by default necessarily needs to be checked in order for the user to proceed to create his/her membership. Other typical information is then collected from the user in order to create a new membership, (physical mailing address, telephone number, etc.). Upon completion of the sign up process, a user has successfully created a membership and can then proceed to donate or acquire an item on the website as recite in steps 104 through 116.

With respect to steps 104 through 116, rather than conducting transactions using a financial currency (e.g. U.S. dollar) the online marketplace utilizes a system of “points” as a virtual currency within the system. Points are accrued in a variety of ways within the online marketplace, such as: (i) receiving initial points upon a new membership, (ii) accruing points as a result of donating an item, and (iii) receiving award points from beneficial behavior as a member (e.g. participation in promotions, awards for referring new members, awards for certain beneficial activities, polls & surveys, etc.).

Typically in preferred embodiments, a specified number of points are given to a new member, providing for a nominal acquire without additional points being necessary. Members can increase the number of points in their account by donating items to other members, and likewise can use their points to acquire items from other members.

While it is not anticipated in the preferred embodiment that points are converted to real currency, in certain applications or embodiments such a conversion to an actual financial currency (e.g. U.S. dollars) can be beneficial. For example, in some embodiments, the ability to acquire additional points using a financial currency could render financial revenue to the operator or owner of such a website, and allow a prospective acquirer to acquire an item that exceeds their current points in their account.

Notwithstanding that in preferred embodiments the online marketplace is cashless and utilizes a virtual currency, further revenue can be generated through web traffic, flat or percentage fees based on sales, or periodic membership dues (as described earlier).

Upon first visiting the website, it is preferable to have a member log into the website as an authorized member with certain credentials, (e.g. email address and password, etc.). It is further preferable to provide a hyperlink to either re-send or reset the membership's account credentials if the user cannot recall the credentials. The member should have the option (via a check box) to save a cookie or utilize other mechanism to have their computer automatically provide a portion or all of the credentials.

Once logged in, typically such a website will direct the member to a personalized “welcome” page. Such a welcome page is preferable to configure in embodiments of the present invention, as it provides a summary of items for donation, items acquired and account balances. Further, a hyperlink to a conventional “my account” web page is highly preferable to configure to provide a vehicle for a given member to edit or otherwise update his/her profile information from time to time (e.g. email address, physical mailing address, password, etc.)

Further preferred embodiments can also have one or more links directing the member to take certain outstanding actions with respect to pending transactions, such as responding to a notification for an offer of acquire, or responding to a notification of a transfer of an item to an acquirer. Preferably, such hyperlinks appearing on the welcome page or the my account page would typically be actions that have also been communicated to the member through an automated messaging means as configured by the website administrator.

As noted above, it is preferable to configure an automated messaging means to notify members when specific events occur, (e.g. a new transaction is initiated, a transfer of an item to an acquirer, etc.) Further, informational or promotional messages can also be incorporated into such communications for efficient use of the website and promotion of website events. Such messaging should follow conventional practices similar to those on other sites, such as eBay or uBid. In general, such messages can further be categorized as “status” messages that do not require action on the member's behalf, or “action” messages that require the user to log into their account and perform a specific action. For example, notification of an offer to acquire an item as recited in step 106 would be considered an action message.

### Posting an Item

When a user wishes to post an item, the user should be brought to a page on the online marketplace which allows them to input information about the item. The process of posting an item for donation from such a page is preferably an intuitive and easy-to-follow process. In present times, website design has progressed to a state that the gathering of information, uploading of one or more photos and categorizing of an item can typically be afforded in a variety of page layouts with easy and efficient instructions.

FIG. 2 is a flow diagram 200 depicting an approach for a donor posting an item for donation in a cashless online marketplace according to one embodiment of the invention. After starting the process in step 202, a donor visits an embodiment of the present invention (e.g. a website) in step 204, typically by utilizing a web browser with a connection to an Internet connection.

In step 206, a donor provides information to the website regarding an item for donation. Preferably, the donor has an opportunity to also submit multimedia files (e.g. still images, moving video, audio files, etc.) that further enhance an advertisement of the item for donation. Typically, such a process of submission of information and files can be implemented in either a single screen or a multi-screen submission process. Preferably, if a multi-screen process is utilized, the screen should provide breadcrumbs and a preview of steps or screens to come. If still image or video files are uploaded to the system, it is further preferable for the website to create a thumbnail (miniature) image of the file which verifies the upload process.

In preferred embodiments of the present invention a website administrator contracts with one or more logistics agents (e.g. UPS, FedEx, U.S. Postal Service, etc.) to handle the transfer of possession of transaction items. The preferable objective being to make the transfer of the transaction items as simple and efficient to use as possible, allowing an acquirer or a donor to coordinate the entire transaction within the website. Preferably, the searching, the offer to acquire, the determination of transfer arrangements and conclusion of the transaction can be conducted from the donor's computer.

At some juncture during the submission of information and files to the website, the donor chooses transfer options as depicted in step 208. This step is intended to set forth one or more acceptable means for the item for donation to be transferred to a prospective acquirer. For example, the following shipping options would typically be available: (i) donor takes responsibility for shipping the package and donor pays the shipping costs, (ii) donor takes responsibility for shipping the package and acquirer pays the shipping costs, (iii) donor delivers the item to acquirer, or (iv) acquirer picks up the item from donor. Note that, except 1 and 2, the choices are not mutually exclusive so more than one option could be selected by the donor. If one of the transfer options is selected by the donor, it is preferable for the donor to be prompted to enter the weight of the item for shipping estimate purposes.

Once the donor has provided all the information and files pursuant to step 204, and the donor has further chosen options for the transfer of the item upon sale, it is preferable that the donor can review all the information, thumbnail(s) and transfer options before submitting the posting in step 210. Namely, a donor would be presented with a screen indicated that the donor should finish and post the item for donation. Upon the click of a selected button, the submission is time stamped and the process concludes in step 212.

Upon submission of the donor's request to post an item, preferably the website proceeds in a timely manner through an automated process to post the item for donation upon the website. Once the posting of a donor's item for donation is effected, members of the website would be capable of viewing the item for donation within the online marketplace.

### Acquiring an Item

FIG. 3 is a flow diagram 300 depicting an approach for an acquirer to acquire an item for donation in a cashless online marketplace according to one embodiment of the invention. After starting the process in step 302, an acquirer visits an embodiment of the present invention (e.g. a website) in step 304, typically by utilizing a web browser with a connection to an Internet connection. In step 306, a member identifies an item to acquire, namely through browsing, searching or having an item appear on a wish list.

In preferred embodiments, the primary means of navigating the site is intended to be accommodated through an easy-to-use, dynamic map of categories. These categories enhance navigation of the website and limit results to those that are pertinent to a user's interaction with the website at a given time. It is further preferable to implement the categories in a menu or other dynamic vehicle on the website page, such that when a user clicks on a parent category, the child subcategories should emerge for display. For a detailed subcategory (e.g. a 3rd level) the categories would preferably only emerge for display if there are items in that category for donation. In advanced embodiments, it is further preferable that following the name of the category, the number of items for donation in that category and all subcategories should be displayed. When viewing an item for donation, it is also preferable to show various data about an item, such as the number of times an item has been viewed.

While it is preferable to also provide a search function in the website, the search functionality is de-emphasized as it is preferable to encourage members to browse by category instead. Search functionality in an online marketplace can be configured using conventional means (e.g. Ajax, etc.). Preferably, results are ordered first by proximity (e.g. ZIP code) with the home area listed first, then by date item was posted with the most recent items first. The keyword found in the items matching the search term is preferably highlighted in the search results page. It is further preferable to be able to have other advanced searching or search results features, such as filtering the results to certain categories, or sorting the results in alternate ways, (e.g. value, location, date posted, alphabetical, delivery options, etc.) Depending on the number of points in the member's account, preferably a column can be configured to reflect whether the member has sufficient points to acquire the item.

As noted in other contemporary online marketplaces, a “wish list” feature is also advantageous to implement, thereby allowing members to configure a website to search for items of a given criteria that become available for donation. Preferably, such a feature can implement the criteria of location, price, category and other attributes typically used in a search function.

Once a member has identified a specific item that the member would like to acquire, the acquirer chooses a delivery option from the available delivery options in step 308. Upon review of the item and selected delivery option, the member then clicks a button, hyperlink or other affirmative action to make an offer to acquire the item from the donor in step 310. The process of making an offer to acquire an item thus progresses and ends in step 312.

Further, in some applications, it can be preferable to allow a member to acquire a nominal number of points; for example, if a member has 80% or more of the points necessary to acquire an item, but does not have sufficient points, the website can provide an option for the member to acquire the item with the points in their account plus a nominal cash price. If such a feature is configured, the equation for acquiring the points in currency, including constants, will need to be manipulated by the website administrators for fairness of all parties.

Following submission of an offer to acquire an item, preferably the website is updated in a timely manner to reflect that the item is either temporarily or permanently no longer available to other members to acquire.

### Closing the Transaction

Returning briefly to FIG. 1, after an acquirer offers to acquire an item in step 106, a notification is sent to the donor of the item and the donor has the option of either accepting or rejecting the acquirer's offer in step 108. This message, among other purposes, serves to confirm that the item is still available for donation by the donor. Typically, such communications are provided by email and provided on the welcome page as earlier described. Preferably, the donor is capable of clicking on one of the choices provided either in the email message or upon a website page following a login by the member at the website. Provided that the donor accepts the acquirer's offer, a process of transferring the item and closing the transaction is undertaken in step 112, as further detailed in FIG. 4.

FIG. 4 is a flow diagram 400 depicting an approach for a closing of a transaction in a cashless online marketplace according to one embodiment of the invention. Following an acquirer's offer to acquire the item and a donor's acceptance of the acquirer's offer, the process in flow diagram 400 is commences in step 402. As noted earlier in FIG. 1, in step 107, a sum of points is deducted from an acquirer's account representing the amount of the transaction. However, the sum of points deducted from the acquirer's account is not yet added to the donor's account; instead, a virtual escrow arrangement inherent in the online marketplace is commenced. Because the donor has not yet accrued the sum of points from the transaction, the donor is encouraged to complete the transaction as soon as practical to accrue the sum of points. Having the sum of points deducted from the acquirer's account immediately in step 107 further prevents the acquirer from over-committing the same points in an acquirer's account for multiple purchases.

Returning to FIG. 4, in step 406 the donor transfers the item to the acquirer pursuant to the designated transfer option chosen by the acquirer in step 308 (from FIG. 3). If the item is transferred by shipping carrier (e.g. UPS, FedEx, U.S. Postal service, etc.) then typically a communication is received by the website (in an automated manner) or the website administrator to verify that the item has been transferred to the acquirer. If the item is transferred by donor delivery or acquirer pickup, or another alternate method where an automated communication will not be received by the website (or the website administrator) of such transfer of the item, then the responsibility of verifying the transfer of the item to the website (or the website administrator) is borne by the donor. Preferably, the donor merely needs to log into the website and click upon a hyperlink to indicate and verify that transfer of the item has taken place.

Following the verified transfer of the item step 406, the acquirer is notified of the item transfer by the website (or website administrator) in step 408. Similar to other action messages or communications, this communication solicits the acquirer to respond to the receipt of the item within a timely period, (such as 48 hours), namely, whether the item is acceptable as received or whether the acquirer disputes the condition or receipt of the item. Such a response is depicted in FIG. 4 by the decision represented in step 410.

If the acquirer responds in step 410 that the item received is acceptable and no dispute is present as illustrated by choice 412, then the sum of points of the transaction are added to the donor's account in step 416.

In preferred embodiments, so as not to delay the transaction, it is advisable to configure the online marketplace infrastructure to automatically default to acceptance of receipt of an item by an acquirer following the expiration of a specified period (such as 48 hours) of non-response. Therefore, an acquirer need not necessarily reply to accept receipt of the item in step 410.

To the contrary, if an acquirer is dissatisfied with the condition, non-receipt or other aspect of the item received from the donor, then acquirer can dispute the transaction through choice 414. As noted above, such a dispute preferably needs to be initiated within a specified time of receipt of the item from donor. Upon initiation of a dispute over the transaction, preferably either the website administrator or another objective party determines whether the donor is at fault in step 418. During the process of resolution of the dispute, the sum of points remains deducted from the acquirer's account but are not credited to the donor's account.

If the donor is not at fault as depicted by choice 420, then points are added to the donors account in accordance with the transaction in step 416. While not depicted on FIG. 4, it can be preferable in certain applications to accrue a demerit against an acquirer for an acquirer's egregious fault or willful misuse of the marketplace by disputing a transaction where the acquirer is at fault.

On the other hand, if the donor is found to have misrepresented the item, the item arrives damaged to the acquirer, or other meritorious reason for the acquirer's dissatisfaction, then the donor is at fault as depicted by choice 422. To encourage honesty and fairness when conducting transactions, a donor at fault should preferably suffer a membership demerit, as depicted by step 424. Typically, even if a donor is found to be at fault, the donor still enjoys a sum of points representing the transaction to be added to the donor's account, as depicted by the solid line running from step 424 to step 416. However, at the discretion of the party resolving the dispute (e.g. online marketplace administrator), an egregious fault or willful misuse of the marketplace on the part of the donor can also result in the donor not enjoying any points from the transaction, as depicted by the dashed line running from step 424 to the end of the process in step 426.

In preferred embodiments, an online marketplace can promulgate preferable terms for fair operation of the marketplace that are ultimately agreed to by each member upon joining the marketplace. Such terms can include specific guidelines regarding deduction, addition and replenishment of points arising from a transaction, as well as demerits that can be accessed against an acquirer or donor in a transaction, both of which can be ultimately placed in the discretion of the marketplace adminstrator. Likewise, it is preferable that after a certain number of demerits (e.g. two demerits or fixed number of demerits as specified by the online marketplace terms of use) then a member can no longer donate items in the online marketplace.

Following steps 416 or 424, depending upon the outcome of the transaction, the closing of the transaction is completed in step 426.

### EXAMPLES

By way of example, consider the following hypothetical scenario of an embodiment of the present invention. Tom and Mary Donaldson have a 12 year old son. He wants to play football for the local peewee team and also has a bike that no longer fits him. Sally Johnson has a 15 year old son who just stopped playing football when he entered high school and now wants to get into film and video. Greg Williams has an 18 year old son who is getting ready to go to college and no longer uses his digital video camera they bought for him last Christmas. Since the Donaldson, Johnson and Williams families do not know of one another, it is highly unlikely that the parties would be aware of one another's needs absent a website or other information center to exchange such information. However, even if such a website existed to make the parties aware of each others' respective goods for donation and needs, it is highly unlikely that such a transaction would be effected in a convenient and efficient manner.

However, if the Donaldson, Johnson and Williams families above are all members of the online marketplace community, the Donaldson family can donate their son's bike to a fourth family whose son has recently outgrown his bike and is in need of a larger size. With the cashless sum of points acquired from the bike sale, the Donaldson family can acquire Sally Johnson's son's used football gear that he no longer needs. With the cashless sum of points acquired from that sale, Sally Johnson can acquire a digital video camera for her son from the Williams family. All families are able to provide for their children's needs at almost no cost.

By way of a second example, consider the following hypothetical scenario of an embodiment of the present invention. The Kirkwood family is expecting a new child. The Kirkwood family doesn't have any of the necessary gear that new parents need and can't afford to acquire it. The Badger family has a four year old son who wants to start skiing, but the Badger family can't afford snow skiing gear either. However, the Badger family has a closet full of baby gear that they never sold or gave away to anyone. Again, in the absence of a vehicle for a transaction between the parties, the parties would not enjoy the benefits of acquiring needed items.

With the sum of points earned from joining the cashless online marketplace community, the Kirkwood family is able to acquire the used baby gear from the Badger family. With a sum of points earned from the sale of their old baby gear, in conjunction with a sum of points earned from joining the cashless online marketplace community, the Badger family then is able to acquire skis, boots and poles from a third family whose child has outgrown them. In sum, all members of the respective families gain value from the transactions. Moreover, on a macro scale, such transactions can provide that baby clothes and snow ski equipment are r, thus recycling goods, providing goods to those who could not afford new goods, and thereby conserving resources on a micro scale and a global scale.

### Group Features

In preferred embodiments, the cashless online marketplace is a membership-based virtual community. As such, members of the virtual community typically have real-world affiliations that are useful to the virtual community. For example, members can belong to a particular neighborhood group, a school, a sports team, a music group, a cultural group, or perhaps a large extended family. These real-world affiliations can increase the usage of the cashless online marketplace, as well as segment the marketplace into useful subdivisions resulting in increased member trust among other benefits.

By implementing special features or benefits for such groups, embodiments of the present invention can offer exclusive trading arrangements, preferential notifications, virtual “swap meets” and other features to increase participation and online commerce. Preferably, such features should be naturally integrated within embodiments of the present invention as an option, but should not limit the operation or features otherwise described in any way.

More particularly, a group is considered a collection of one or more members that are affiliated in a common way, and identified within the cashless online marketplace as such. A group may have a primary member administrator, or it can be created and maintained by the administration team of the marketplace. Preferably, an external link can be provided within the cashless online marketplace that provides an avenue for members to reach the group's primary website for further information unrelated to the marketplace (e.g. home page, group schedules, etc.). Other features such as group communications can also be implemented, affording additional features to group administrators or members.

As members belong to a group, and items belong to members, items can be categorized as belonging to groups if advantageous under the circumstances. However, typically in preferred embodiments there is no particular “group account” and thus items always belong to a member.

In other embodiments, however, if it serves the circumstances, a group account or member representative of the cumulative group can be created to receive or donate items. Depending up on the implementation, it can be advantageous to have statistics posted to members within the group indicating the number of transactions or other quantifiable figures regarding the group activities.

Another feature that can be implemented in preferred embodiments is a limitation that certain items only be available to other members of a given group. However, if a member views an item that is currently only available to a group, and the member is not part of that group, the option to trade for the item can be configured such that it is not available to that member. In preferred embodiments, however, the member can still be allowed to send the donating member a message. Further, it is preferable that for group private items, there should be a specific number of days until the item will be available to the broader marketplace. It is further preferable to afford a means for a member in the marketplace who is not a member of a given group to join such a group. This can be accommodated through the marketplace itself or through an external link provided through the marketplace.

Thus, when an item is posted, additional information needs to be added to indicate if the item belongs to one or more groups in the marketplace. The posting member can choose whether to make an item exclusive to their group, available to several groups or available to the membership at large.

Administrators of the marketplace, or administrators of specific groups, preferably can receive reports associated with one or more groups. Such reports can provide bulk information such as membership lists, contact information, transaction information related to a group, or other metrics.

When implemented, the aforementioned group features can help cultivate new members into the cashless online marketplace, increase transactions in the marketplace, create new associations between members and further promote goodwill amongst groups in the community at large. For example, a first mother of children can introduce a second mother to a mother's club for which the first mother is a member. The first mother can direct the second mother to the online cashless marketplace and the second mother can immediately take advantage of an exchange of goods/services and communications, rather than wait for the traditional means of communications at the next meeting or next newsletter to arrive.

Similarly, in a second example assume that a school desires to sponsor a swap meet. The swap meet can be accomplished online with far fewer volunteers and resources required. Embodiments of the present invention provide a way to allow busy parents to attend the swap meet on their own schedule, while still supporting the preschool's private event. For example, the swap meet can run for a period of one month or other specified time period, thereby providing ample opportunity for all to view/acquire the times online and attend, (a compared to physically attending on a Saturday which may or may not work for prospective attendees' schedules). Such a sponsored event can take place without the necessity of a physical site, without the risks of weather or other circumstances, and accommodate the conveniences of one's own chosen time and environment.

### Charity Features

In certain circumstances, it is highly advantageous to create a membership for an existing or to-be-formed non-profit or charitable organization, also known as a “charity”, (such as a 501(c)(3) organization under Internal Revenue Service (IRS) regulations). Thus, when goods or services are provided or administrated through such a charity member, the donor can receive a tax benefit in the form of a donation receipt instead of cashless points in the marketplace. There are several embodiments possible under this category.

For example, in a first embodiment, a member can designate that an item being posted to be donated to a charitable or non-profit organization. An acquiring member thereafter requests the item. Upon approval by the donor and optionally the charity, the transaction takes place. Namely, in the outcome of the transaction, the donor receives a tax receipt, the acquiring member receives the item and the charitable organization receives points in the marketplace.

As can be observed, all three parties benefit from the transaction. A donor has relieved itself of an unneeded item and received a tangible tax benefit. A recipient receives a needed item; and, of course, the charity is able to fulfill its purpose in providing a needed item to the recipient as well as receive marketplace points to acquire additional items to distribute to other recipients.

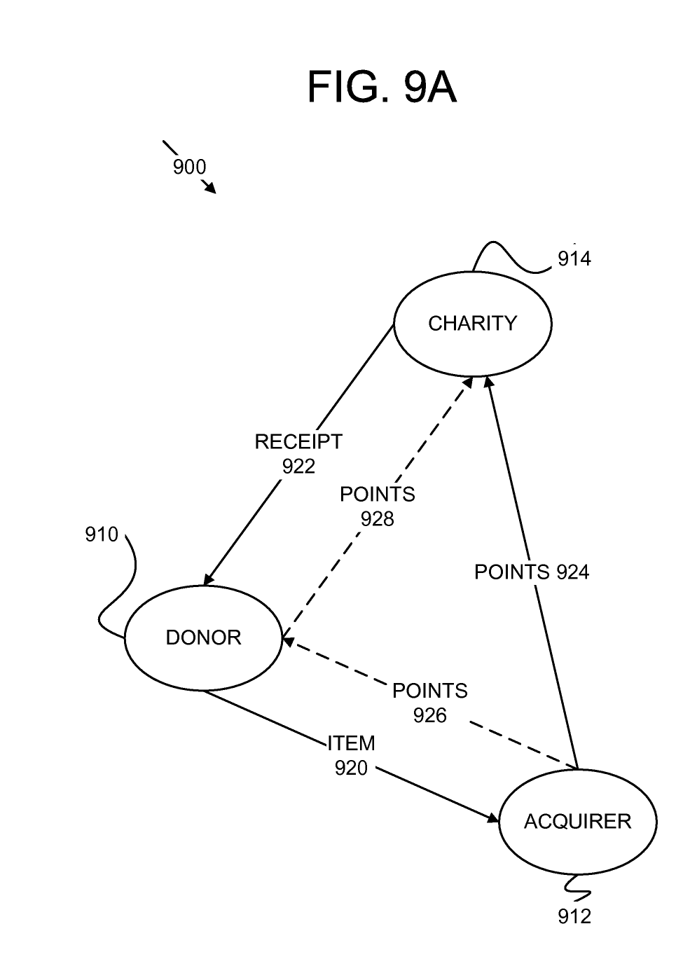

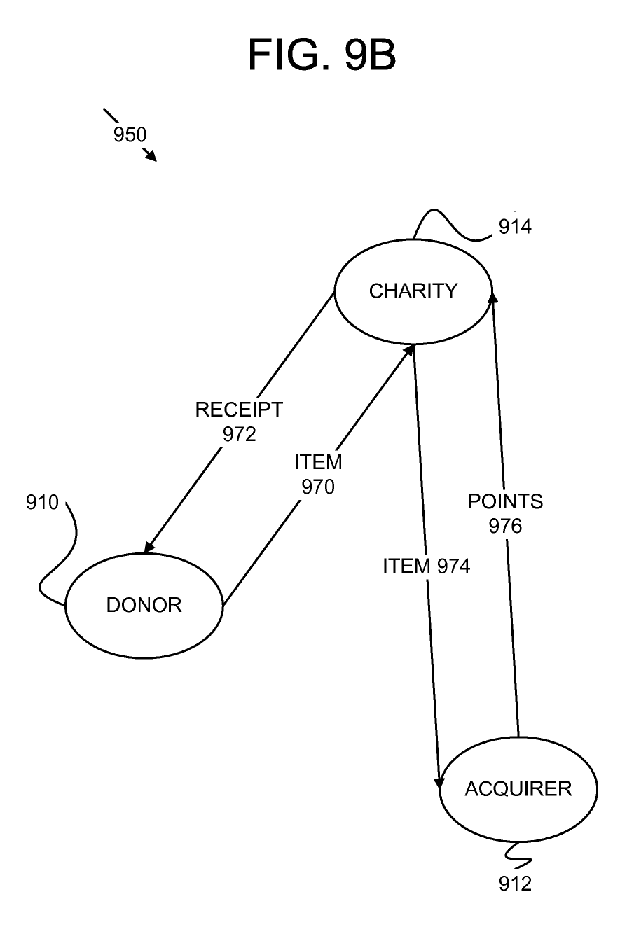

More particularly, turning to FIG. 9A, a diagram 900 illustrates such a transaction occurring between a donor 910, an acquirer 912 and a charity 914. Donor 910 posts an item 920 available for purchase in the marketplace, which is identified as being donated to the charity 914. Acquirer 912 requests the item 920 and the item 920 is provided to acquirer 912, as indicated by the arrow from donor 910 to acquirer 912. Upon receipt and approval of the item 920 from donor 910, acquirer 912 provides points to charity 914 for the receipt of item 920, as indicated by the arrow from acquirer 912 to charity 914. Further, a receipt 922 is provided online to donor 910, as depicted by the arrow from charity 914 to donor 910.

As a matter of keeping a clean, auditable ledger in the administration of the marketplace, it is advisable that the transfer of points 924 from acquirer 912 to charity 914 be effected by two transfers of points, namely points 926 transferred from acquirer 912 to donor 910, and points 928 transferred from donor 910 to charity 914. Likewise, it is preferable for tax and accounting purposes to have the legal ownership of the item 920 flow from the donor 910 to the charity 914 to the acquirer 912 (not shown).

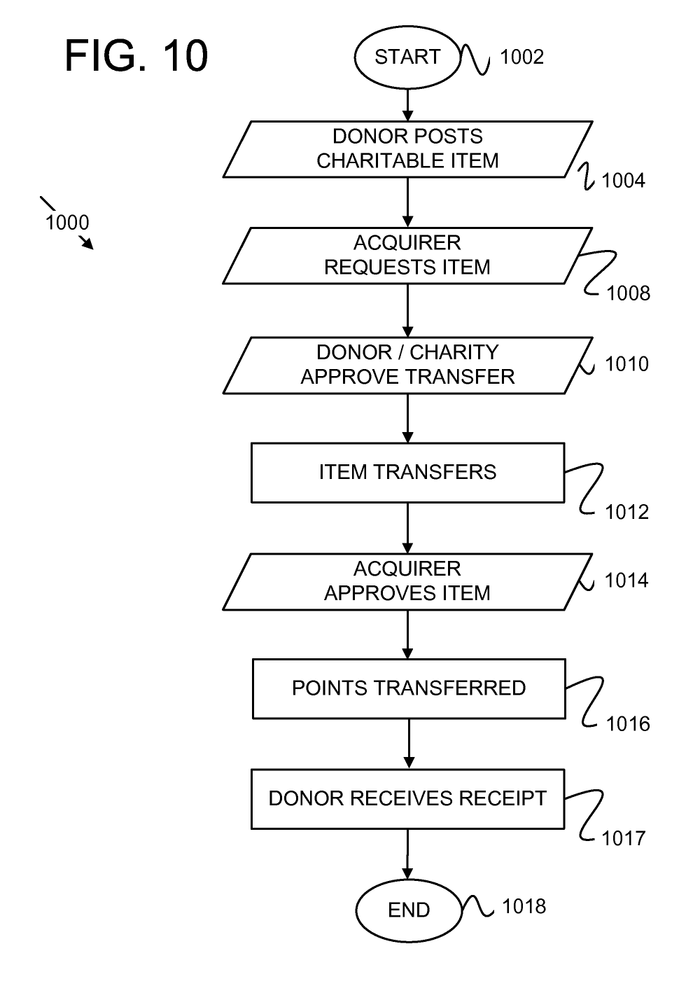

The steps of the above described method are further illustrated in FIG. 10. More specifically, a flow diagram 1000 depicts the steps for a typical charitable donation transaction. The process begins with step 1002 and ends with step 1018.

In step 1004, a donor provides an item for donation to a charity. The item is posted on the marketplace with an indication that it is being provided for charitable purposes to an identified charitable organization member. In step 1008, an acquirer identifies and requests the item posted by donor. Upon the approval of the transaction by donor (or optionally the charity) in step 1010, the item is subsequently transferred to the acquirer in step 1012. (See below, as it is noted that for tax purposes and accounting clarity, the legal ownership flow through the charity from the donor to the acquirer). Similar to other transactions in the marketplace, no points are transferred until the acquiring party is satisfied with the item. Upon such approval in step 1014, points from the acquirer are transferred to the charity in step 1016. Likewise, as previously described above, the points transfer is preferably accommodated in the form of two transfers through the intermediary donor for tax and accounting purposes). In step 1017, at the conclusion of the transaction, the donor is presented with a receipt for the transaction. Preferably the receipt in step 1017 is printable and conforms to governmental regulations for tax return purposes.

More particularly, for tax regulation purposes it is typically preferable that such a receipt reflect a contribution of the actual item rather than a sum of points from the donor. Since typical tax regulations require a contribution of physical goods (e.g. clothing, furniture, bicycle, etc.), it is further preferable that even if the item is physically transferred from the donor to the acquirer, that the legal ownership of the item flow from the donor to the charity, and from the charity to the acquirer. In doing so, the donor is capable of rightfully claiming a physical good was provided to the charity for tax purposes.

In an alternate embodiment, a charity member can be setup as a recipient of points from other members. With these points provided by various other members, the charity can then acquire and distribute goods in accordance with its charitable purpose. For example, a first member could provide 200 points to a charity member. The charity member can then acquire and provide needed items to a second member using the 200 points provided by the first member. In return for the original contribution, the charity member provides the first member a tax receipt for its contribution. Again, all three parties benefit from the related transactions.

More particularly, such an alternate set of transactions is illustrated in FIG. 9B as a diagram 950. The donor 910, acquirer 912 and charity 914 perform similar roles as those described in diagram 900 of FIG. 9A; however, the transaction is accommodated through independent transactions made with charity 914 which do not necessarily have to be within the same proximate time frame. Initially, donor 910 donates an item 970 to charity 914. Charity 914 takes possession of the item 970 and provides a receipt 972 to donor 910. At a subsequent time, charity 914 provides acquirer 912 with the item 974 and in return, optionally receives points from acquirer 912 that are transferred to charity 914.

In both of the models described above, a given charity can act also in the capacity as an acquirer, thus obtaining items in the marketplace as needed to fulfill its purposes, while also serving as the charity member.

As some members of the marketplace can be prone to take a higher interest in donating or acquiring goods having an affiliation to a certain charity, it is preferable to make such affiliations or associations clearly visible on the item's web page. It is further preferable to have specific lists, searches or filters to easily identify both members and items associated with a charity member.

Similar to the groups feature discussed above, the online cashless marketplace preferably provides additional administrative, posting and receiving options on its interface to effect the charity functions. In particular, preferred embodiments of the present invention should have a special form with comprehensive information fields to allow the charity to provide all necessary information to validate its non-profit status, (e.g. a field to provide its “EIN” number from the IRS). Once enrolled in the marketplace as a charity member, members can post and acquire items through the charity similar to the examples given above.

As a first example of the charitable organization feature described above, a charitable organization providing social services to families in need acquires items in the open market or via donations and passes them along to families in need. In preferred embodiments of the present invention, the charitable organization would setup itself as a charity member. The administration of the marketplace would verify their non-profit status and enable the charitable member account. Subsequently, a donating member whose children have moved on to college have a number of items to donate. The donating member posts a teenage bicycle, and indicate the proceeds to be provided to the charity member.

A second member of the marketplace identifies the bicycle on the marketplace as something to acquire for their teenage child's upcoming birthday, which otherwise is not affordable under their family budget. The second member requests the transaction, which is approved by the donor (and optionally by the charity member) as well. Subsequently, the second member family picks up the bicycle and approves the transaction. Ultimately, points are transferred from the second member to the charity member. Note, that while transparent to the second member and charity member, it is preferable for internal system ledger purposes that the points first transfer to the donor member and immediately from the donor member to the charity member. Upon the conclusion of the transaction, the donating member is provided with an online (printable) tax receipt indicating the item is being donated to the charity. The donating member could submit this tax receipt with their annual income taxes for a financial benefit.

In the above example provided, an unneeded bicycle has been transferred to a family in need, a tax benefit has been rendered to the donor, and the charity has furthered its purpose in providing social services to those in need.

As a second example, assume that a local school district or non-profit organization sponsors an after school baseball league for children from low-income housing neighborhoods. In doing so, a number of baseball shoes and other sporting equipment is required. Donating members can provide the shoes directly to the baseball league as a charity member, and receive a tax benefit. The baseball league can distribute the shoes to its players, optionally garnering points from its families or players within the marketplace as well. All of the transactions, as anticipated in this example—utilize the benefit of real-time, convenient features of an online cashless marketplace.

In yet a third example of charitable features described herein, assume that a natural disaster has decimated an entire county. Families are trying to replace many things that have been lost for their children. In doing so, they can use the online cashless marketplace to advertise what items they need. Specific member families can create a wish list or other indication of items that are badly needed. A sponsoring non-profit organization established to provide such need (e.g. Red Cross, etc.) can be enrolled as a charity member in the marketplace. Subsequently, and similar to the above examples, a donating member can provide the items directly to those in need, or through the charity member, thereby receiving a tax benefit from their donation. All of the above transactions are convenient, reliable and verifiable to all parties and conducted with an increased level of efficiency over traditional methods of physical or traditional communication means.

### Implementation Mechanisms

The approach described herein and infrastructure required for conducting a transaction in a cashless online marketplace can be implemented in hardware circuitry, in computer software, or a combination of hardware circuitry and computer software and is not limited to a particular hardware or software implementation.

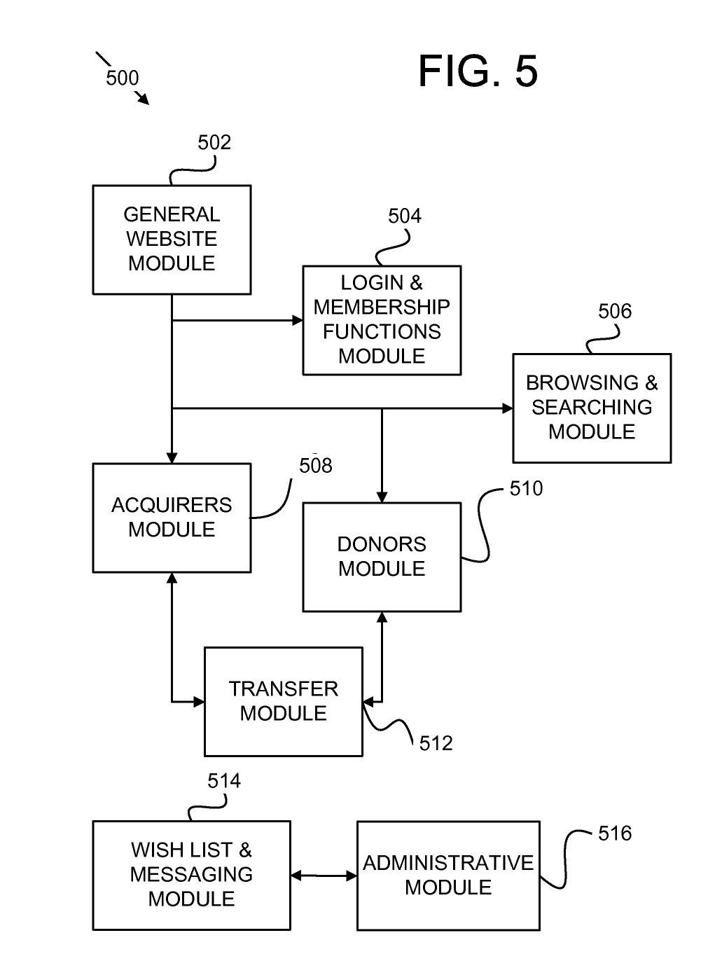

FIG. 5 is a logical block diagram 500 illustrating a software architecture capable of implementing one or more of the above disclosed embodiments of the invention. While the modules described can be combined in fewer modules or split into additional modules, the suggested modules as depicted are chosen to describe hardware or software modules that contain related groupings of functions performed by the cashless online marketplace infrastructure.

More particularly, a general website module 502 serves as an interface and overall structure to organize other modules of the website. A login and membership functions module 504 handles login, authentication and other membership related tasks such as signup and updating of member profiles. A browsing and searching module 506 provides users of the website with the ability to find and view items for donation on the online marketplace.

Actions or web pages relating to the process of acquiring an item on the online marketplace are handled in an acquirer's module 508, such as steps 306 through 310 appearing in FIG. 3. Likewise, actions or web pages relating to the posting of an item or other donor's functions are handled in module 510, such as steps 206 through 210 appearing in FIG. 2. Both the acquirer's module 508 and donor's module 510 necessarily interface to a transfer module 512, which preferably interfaces to a third party transfer agent (not shown) such as a shipping carrier (e.g. UPS, FedEx, U.S. Postal Service, etc.) or other transfer agent. Preferably, such an interface provides the online marketplace with shipping estimates and transfer verifications.

A wish list and messaging module 514 acts as an agent to update member wish lists and provide notices to members and other users. An administrative module 516 provides management functions to website administrators and all remaining functions of the website unrelated to the functions described above. Note that since the wish list and messaging module 514 and the administrative module 516 are not connected to the general website module 502 in FIG. 5, these modules are preferably operated and accessed through a secure interface or connection (not shown) other than that of the public pages of the website.

The above described modules can typically be written in any contemporary web development language by one skilled in the art, preferably utilizing and customizing off-the-shelf or open source features for database, searching, indexing, security and administrative functions.

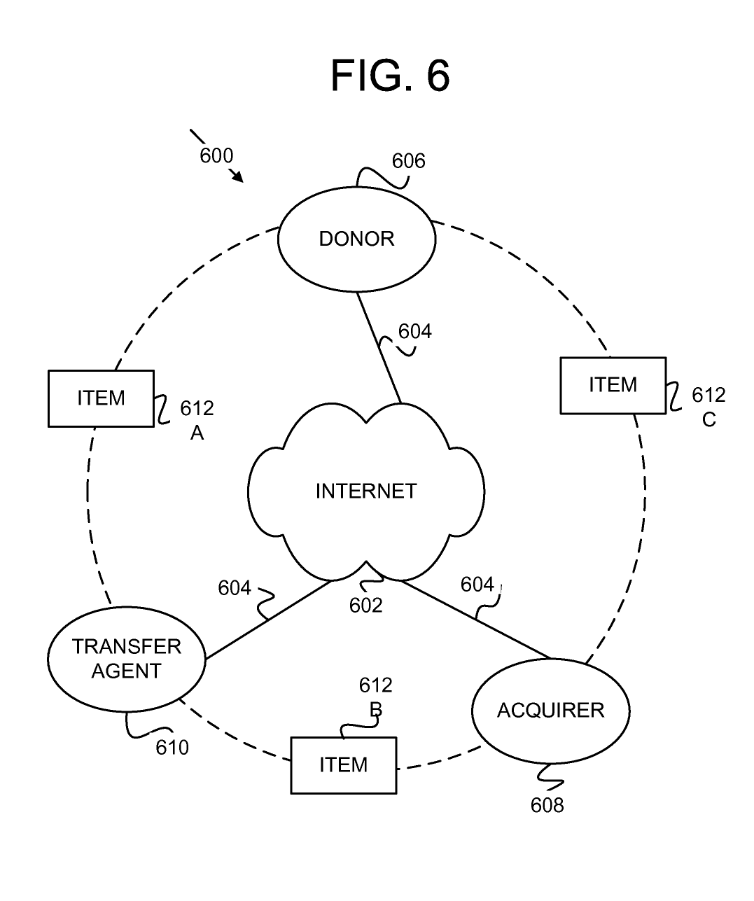

Turning to FIG. 6, an approach depicting a cashless online marketplace on the Internet is now described. FIG. 6 is a block diagram 600 depicting the connectivity of a world wide network, such as the Internet, for the conducting of a transaction in a cashless online marketplace.

By way of example, a donor 606 is connected to an Internet 602 through an Internet connection 604. Utilizing the connection 604, the donor 606 posts an item 612 for donation in the online marketplace (not shown). Likewise, an acquirer 608 is connected to the Internet 602 through an Internet connection 604. Utilizing the connection 604, the acquirer 608 offers to acquire an item 612 appearing in the online marketplace (not shown). As depicted by an item 612C, in one case the donor 606 can directly provide the item 612C to the acquirer 608. Alternatively, in another case the donor 606 can provide the item 612A to a transfer agent 610, where, subsequently, the transfer agent 610 transfers the item 612B to the acquirer 608. In discharging its duties to provide shipping estimates (not shown) and provide verifications of transfer to the online marketplace (not shown), the transfer agent 610 is also connected to the Internet 602 through an Internet connection 604.

It is appreciated that the Internet connection 604 can take any number of forms of communication, but is preferably implemented as electronic communication via a wide area network such as the Internet. It is further appreciated that various distinct entities described in the above method and system, namely the donor 606, acquirer 608 and transfer agent 610 can be the same or different legal entities.

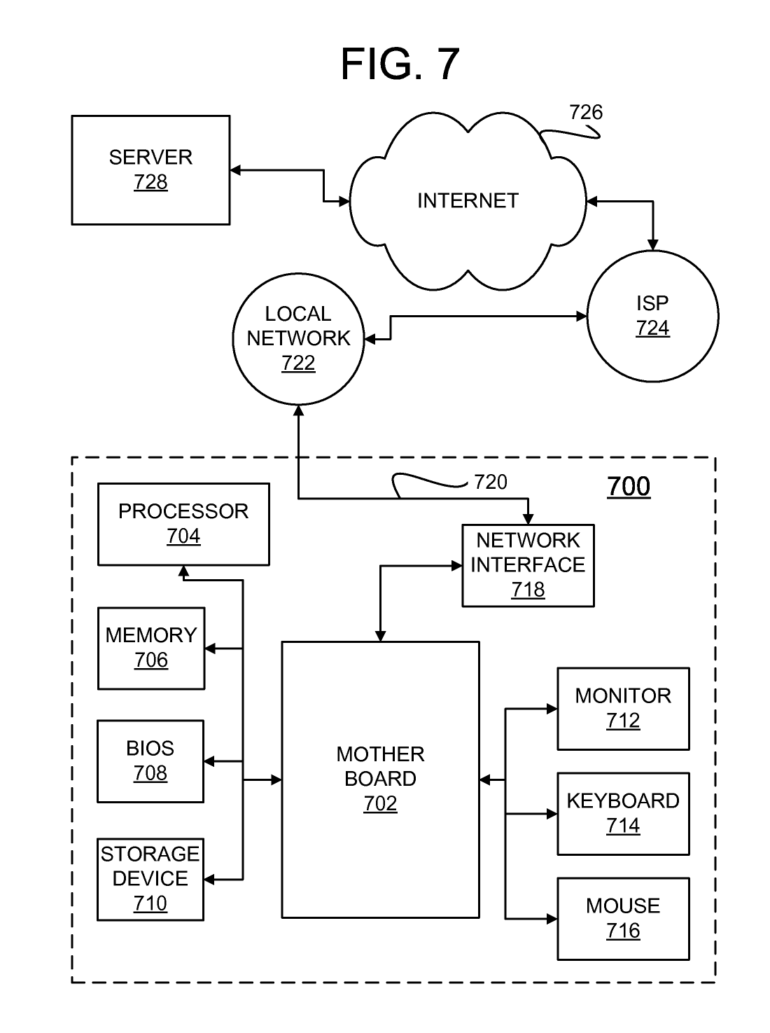

Turning to FIG. 7, a block diagram illustrates a computer 700 upon which an embodiment of the invention may be implemented. Computer 700 includes a motherboard 702 or other communication mechanism for communicating information, and a processor 704 coupled with motherboard 702 for processing information. Computer 700 also includes a memory 706, such as a random access memory (RAM) or other dynamic storage device, coupled to motherboard 702 for storing information and instructions to be executed by the processor 704. Memory 706 also may be used for storing temporary variables or other intermediate information during execution of instructions to be executed by processor 704. Computer 700 further includes a basic input output system (BIOS) 708 or other static storage device coupled to motherboard 702 for storing static information and instructions for processor 704. A storage device 710, such as a magnetic disk or optical disk, is provided and coupled to bus 702 for storing information and instructions.

Computer 700 may be coupled via motherboard 702 to a monitor 712, such as a cathode ray tube (CRT) or liquid crystal display (LCD) for displaying information to a computer user. A keyboard 714, including alphanumeric and other keys is coupled to motherboard 702 for communicating information and command selections to processor 704. Another type of user input device is a mouse 716, such as a mouse, a trackball, or cursor direction keys for communicating direction information and command selections to processor 704 and for controlling cursor movement on monitor 712. This input device typically has degrees of freedom in two axes, a first axis (e.g., x) and a second axis (e.g., y), that allows the device to specify positions in a plane.

The invention is related to the use of computer 700 as a conduit for information transmission with a server 730. To further clarify, such information can, by way of example, include information regarding personal and billing information from prospective members of the online marketplace, items for donation or other information. According to one embodiment of the invention, the conducting of a transaction on the online marketplace is provided by computer 700 in response to processor 704 executing one or more sequences of one or more instructions contained in memory 706. Such instructions may be read into memory 706 from another computer-readable medium, such as storage device 710. By way of example, the server 730 can also be a separate computer system or infrastructure similar to the computer 700 depicted.

Execution of the sequences of instructions contained in memory 706 causes processor 704 to perform the process steps described herein. One or more processors in a multi-processing arrangement can also be employed to execute the sequences of instructions contained in memory 706. In alternative embodiments, hard-wired circuitry can be used in place of or in combination with software instructions to implement the invention. Thus, embodiments of the invention are not limited to any specific combination of hardware circuitry and software.

The term “computer-readable medium” as used herein refers to any medium that participates in providing instructions to processor 704 for execution. Such a medium can take many forms, including but not limited to, non-volatile media, volatile media, and transmission media. Non-volatile media includes, for example, optical or magnetic disks, such as storage device 710. Volatile media includes dynamic memory, such as memory 706. Transmission media includes coaxial cables, copper wire and fiber optics, including the wires that comprise motherboard 702. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 704 for execution. For example, the instructions may initially be carried on a magnetic disk of a remote computer. Motherboard 702 carries the data to and from memory 706, from which processor 704 retrieves and executes the instructions. The instructions received by memory 706 may optionally be stored on storage device 710 either before or after execution by processor 704.

Computer 700 also typically includes a network interface 718 coupled to motherboard 702. Network interface 718 provides a two-way data communication coupling to a network link 720 that is connected to a local network 722. For example, network interface 718 may be a digital subscriber line (DSL) modem, satellite dish, an integrated services digital network (ISDN) card or other data communication connection to a corresponding type of telephone line. As another example, communication interface 718 may be a local area network (LAN) card effecting a data communication connection to a compatible LAN. Wireless communication means such as internal or external wireless modems can also be implemented.

In any such implementation, network interface 718 sends and receives electrical, electromagnetic or optical signals that carry digital data streams representing various types of information. Network link 720 typically provides data communication through one or more networks to other data devices. For example, network link 720 may effect a connection through local network 722 to a host computer 724 or to data equipment operated by an Internet Service Provider (ISP) 724. ISP 724 in turn provides data communication services through the world wide packet data communication network now commonly referred to as the Internet 726. Local network 722 and Internet 726 can use electrical, electromagnetic or optical signals that carry digital data streams. The signals through the various networks and the signals on network link 720 and through network interface 718, which carry the digital data to and from computer system 700, are exemplary forms of carrier waves transporting the information.

Computer 700 can send messages and receive data, including program code, through the network(s), network link 720 and network interface 718. In the Internet example, a server 728 might transmit a requested code for an application program or a web page through Internet 726, ISP 726, local network 722 and network interface 718. In accordance with the invention, one such downloaded application or web page provides for the information presented to the user on the screen at the time requested—whether that be a user, member or administrator of the website. The received code may be executed by processor 704 as it is received, and/or stored in storage device 710, or other non-volatile storage for later execution. In this manner, computer 700 may obtain application code (possibly originating as a web page) information in the form of a carrier wave.

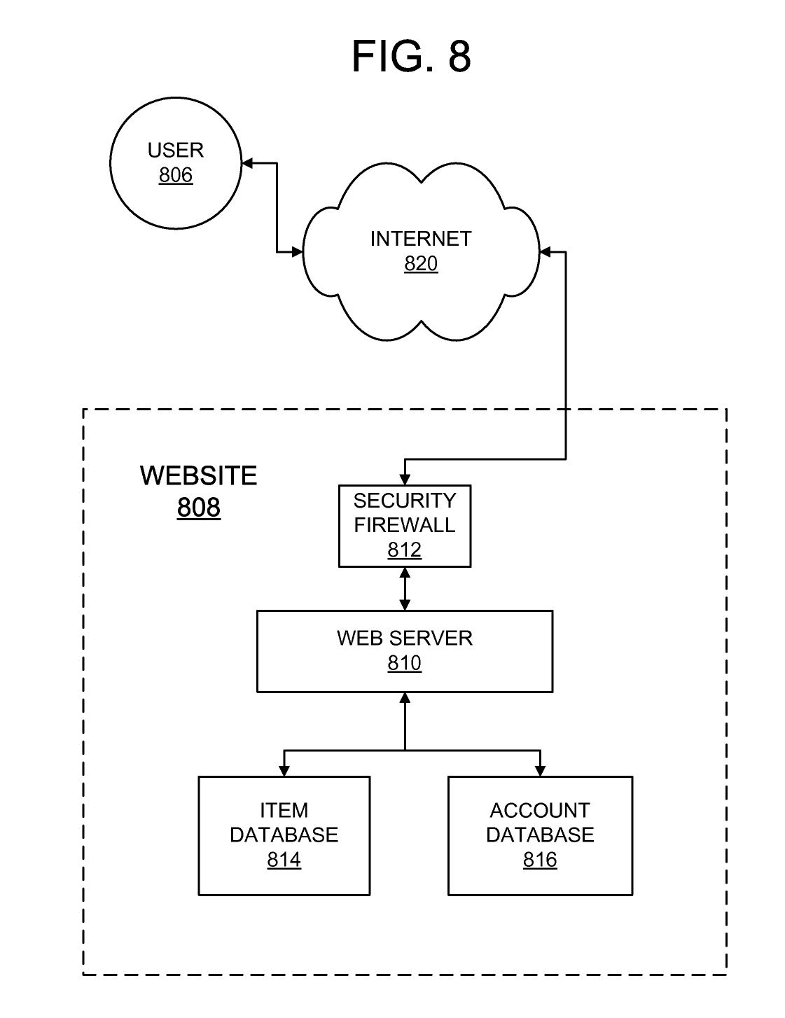

Turning to FIG. 8, an exemplary computer-implemented embodiment of the present invention is illustrated via the relationships between various components in the infrastructure of a cashless online marketplace as a website 808 and a user's computer 806, thereby connected through an Internet 820. The most basic components of infrastructure of a website 808 can be described as having a web server 810, an item database 814 and an account database 816. Optionally and preferably, the system consists also of a security firewall 812.

With respect to the steps of such a method of transacting an item, a user 806 logs onto the web page of a website 808 via an Internet 820 connection. Web pages are provided by a web server 810 that preferably has a security firewall 812 installed to prevent unauthorized activity across the Internet 820 connection.

The web server 810 is a device which serves as a front interface or vehicle to provide and solicit information to/from a provider 106 regarding the particulars of a given page request or transaction, (e.g. delivering a web page, presenting information about a membership, soliciting information to post an item, etc.). Web server 810 acquires and delivers information to and from the item database 814, which typically comprises a database containing data related to such items made available for donation, (e.g. past and present items for donation, etc.). Web server 810 can take the form of any number of common web servers known in the art, such as an Apache web server or a Microsoft Windows .NET server platform. The security firewall 812 can likewise be any number of security devices or parameters typically installed on web servers known in the art, such as a Cisco PIX security appliance.

As desired, website 808 can configure web server 810 to also present information on web pages from an account database 816, typically containing member-related data of the website 808, (e.g. email address, billing information, physical mailing address, etc.) that is associated with a given membership.

Preferably, information and data between the account database 816 and item database 814 should be shared and reconciled between the databases. If the databases are in separate proprietary formats, (e.g. such as a Microsoft SQL database server and a non-SQL database server), then it is preferable to have a translation module (not shown) to translate, share and reconcile the data between the respective databases.

Utilizing the aforementioned described system illustrated in FIG. 8, a website 808 can readily provide an infrastructure for a cashless online marketplace.

### CONCLUSION

The novel approaches described herein provide significant advantages of efficiency, reliability and convenience in transacting goods in a cashless online marketplace. The above disclosure describes in detail an exemplary, comprehensive method and system for the conducting of a transaction of an item in a cashless online marketplace for used children's clothing and goods. Additional embodiments of the present invention are also anticipated in vastly different scopes and contexts that could range from specialty goods (e.g. Mercedes auto parts, quilting materials, etc.) to general goods to services (e.g. cleaning services, construction services, etc.).

Unless otherwise indicated, all numbers expressing quantities used in the specification and claims are to be understood as being modified in all instances by the term “about” or “approximately.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. If specific results of any tests are reported in the technical disclosure, any numerical value inherently can contain certain errors necessarily resulting from the standard deviation found in the respective testing measurements.

The terms “a” and “an” and “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”, “in the case”, “by way of example”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is herein deemed to contain the group as modified thus fulfilling the written description of all Markush groups used in the appended claims.

Preferred embodiments of this invention are described herein, including the best mode known to the inventors for carrying out the invention. Of course, variations on those preferred embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, if references have been made to patents and printed publications in this specification, then each of the above cited references and printed publications, if any, are herein individually incorporated by reference in their entirety.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

What is claimed is:

1. A computer-implemented method for conducting a cashless online transaction, comprising the steps of:
a donor posting an item for donation, wherein the item is designated as a contribution to a charity;
an acquirer offering to acquire the item;
the donor accepting the acquirer's offer to acquire the item;
transferring the item from the donor to the acquirer;
the acquirer either accepting or disputing the cashless online transaction; and,
closing the cashless online transaction.

2. The computer-implemented method for conducting a cashless online transaction of claim 1, wherein the item for donation is posted at a sum of points and the step of closing the cashless online transaction comprises the step of deducting the sum of points from the acquirer and providing the sum of points to the charity.

3. The computer-implemented method for conducting a cashless online transaction of claim 2, wherein the step of deducting the sum of points from the acquirer and providing the sum of points to the charity comprises the following steps:
deducting the sum of points from the acquirer and providing the sum of points to the donor; and,
deducting the sum of points from the donor and providing the sum of points to the charity.

4. The computer-implemented method for conducting a cashless online transaction of claim 1, further comprising the step of:
notifying the acquirer that the item has been transferred.

5. The computer-implemented method for conducting an online cashless online transaction of claim 4, wherein the step of notifying the acquirer that the item has been transferred from the donor to the acquirer occurs by one or more from the set comprised of the following communication means: electronic mail, instant message, facsimile, telephone and postal mail.

6. The computer-implemented method for conducting a cashless online transaction of claim 1, further comprising the step of the acquirer identifying an item to acquire preceding the step of the acquirer offering to acquire the item.

7. The computer-implemented method for conducting a cashless online transaction of claim 1, further comprising the step of:
the charity providing a receipt to the donor reflecting the item as a contribution to the charity;

8. The computer-implemented method for an acquirer to acquire goods and services at a cashless online marketplace as recited in claim 1, further comprising the step of:
the acquirer paying a sum of actual financial currency to the cashless online marketplace thereby providing sufficient points in the acquirer's account for the acquirer to acquire the item identified in the step of the acquirer identifying an item to acquire at the cashless online marketplace.

9. A computer-readable medium for an acquirer to acquire goods and services at a cashless online marketplace, the computer-readable medium carrying one or more sequences of one or more instructions which, when executed by one or more processors, cause the one or more processors to perform the computer-implemented steps of the method of claim 1.

10. An apparatus for an acquirer to acquire goods and services at a cashless online marketplace, comprising:
one or more processors; and
a memory communicatively coupled to the one or more processors, the memory including one or more sequences of one or more instructions which, when executed by the one or more processors, cause the one or more processors to perform the steps of the method of claim 1.

11. A computer-implemented method for the transaction of goods and services between an acquirer and a donor at a cashless online marketplace, comprising the steps of:
the donor receiving an invitation to join the cashless online marketplace;
the donor visiting the cashless online marketplace pursuant to the invitation;
the donor posting an item for donation at the cashless online marketplace, wherein the item is designated as a contribution to a charity;
the charity providing a receipt to the donor reflecting the item as a contribution;
the acquirer receiving an invitation to join the cashless online marketplace;
the acquirer visiting the cashless online marketplace pursuant to the invitation;
the acquirer becoming a member of the cashless online marketplace and thereby receiving an initial sum of points into an acquirer's account;
the acquirer identifying the item to acquire at the cashless online marketplace;
the acquirer offering to acquire the item at the cashless online marketplace;
an acquirer offering to acquire the item;
the donor accepting the acquirer's offer to acquire the item;
transferring the item from the donor to the acquirer;
the acquirer either accepting or disputing the cashless online transaction; and,
closing the cashless online transaction.

12. The computer-implemented method for conducting a cashless online transaction of claim 11, wherein the item for donation is posted at a sum of points and the step of closing the cashless online transaction comprises the step of deducting the sum of points from the acquirer and providing the sum of points to the charity.

13. The computer-implemented method for conducting a cashless online transaction of claim 12, wherein the step of deducting the sum of points from the acquirer and providing the sum of points to the charity comprises the following steps:
deducting the sum of points from the acquirer and providing the sum of points to the donor; and,
deducting the sum of points from the donor and providing the sum of points to the charity.

14. The computer-implemented method for conducting a cashless online transaction of claim 11, wherein the item for donation is posted at a sum of points and the method further comprises the following step following the step of transferring the item from the donor to the acquirer:
notifying the acquirer that the item has been transferred.

15. The computer-implemented method for conducting a cashless online transaction of claim 11, further comprising the step of the acquirer identifying an item to acquire preceding the step of the acquirer offering to acquire the item.

16. The computer-implemented method for an acquirer to acquire goods and services at a cashless online marketplace as recited in claim 11, further comprising the step of:
the acquirer paying a sum of actual financial currency to the cashless online marketplace thereby providing sufficient points in the acquirer's account for the acquirer to acquire the item identified in the step of the acquirer identifying an item to acquire at the cashless online marketplace.

17. A computer-readable medium for an acquirer to acquire goods and services at a cashless online marketplace, the computer-readable medium carrying one or more sequences of one or more instructions which, when executed by one or more processors, cause the one or more processors to perform the computer-implemented steps of the method of claim 11.

18. An apparatus for an acquirer to acquire goods and services at a cashless online marketplace, comprising:
one or more processors; and
a memory communicatively coupled to the one or more processors, the memory including one or more sequences of one or more instructions which, when executed by the one or more processors, cause the one or more processors to perform the steps of the method of claim 11.

19. A computer-implemented method for conducting a cashless online transaction, comprising the steps of:
a donor posting an item for donation, wherein the item is designated with a group within the marketplace;
an acquirer that is a member of the group offering to acquire the item;
the donor accepting the acquirer's offer to acquire the item;
transferring the item from the donor to the acquirer;
the acquirer either accepting or disputing the cashless online transaction; and,
closing the cashless online transaction.

20. The computer-implemented method for an acquirer to acquire goods and services at a cashless online marketplace as recited in claim 19, wherein the item designated with a group is available for acquisition only to members of the group.
